(19) United States
(12) Patent Application Publication
(10) Pub. No.: US 2002/0079475 A1
(43) Pub. Date: Jun. 27, 2002

(54) Portable cooler valve activator

(76) Inventor: James F. Weir, La Mesa, CA (US)

Correspondence Address: Gary L. Eastman, Esq., EASTMAN & ASSOCIATES, Suite 306, 520 West Ash Street, San Diego, CA, 92101, US

(21) Appl. No.: 09/750,509

(22) Filed: Dec. 26, 2000

(51) Int. Cl. F16K 31/00

(52) U.S. Cl. 251/291; 222/505

(57) ABSTRACT

A Portable Cooler Valve Activator includes a body, plunger tab, capturing tabs, flange gaps, ridge dimples, strap hole, and textured area. A Portable Cooler Valve Activator enables a user to maintain a valve plunger of variable sizes and depths in a depressed position. A Portable Cooler Valve Activator also allows a user to have both hands free from holding the valve plunger or Portable Cooler Valve Activator so both hands may be used to wash or hold a glass of fluid. The use of a Portable Cooler Valve Activator results in cleaner hands, valve, and plunger.

### FIELD OF THE INVENTION

The present invention relates generally to portable devices used to store fluids. More specifically, the present invention pertains to valves used to discharge fluids from a portable cooler. The present invention is particularly useful for activating the valve of a portable cooler so that the fluid continuously flows from the portable cooler.

### BACKGROUND OF THE INVENTION

The need for the storage and use of fluids in remote locations has resulted in the creation of a variety of portable cooler products. These products usually include a protruding valve extending from the lower area of a side or near the bottom of a portable cooler. These valves, however, are usually only suited for brief periods of use.

Typically, a person stores water or other fluids used for drinking or washing dirty hands. In both instances, a person must press and hold the plunger of the valve in its open position. Once released, a spring within the valve returns the plunger to its original position. The spring is made strong enough to push the valve closed when the cooler is full of fluid. As a result, a person may often strain his or her fingers and hands trying to hold the plunger in a depressed position for an extended period.

In addition, the fluid can also be used to wash hands or other dirty objects. In order to do this, however, a person must depress the plunger and hold the plunger in its depressed position with one hand, while attempting to wash the other hand by itself. The process of washing ones hands is usually done by rubbing a bar of soap between two hands. Trying to wash a hand with only one hand is very difficult. The valve usually gets dirty because either hand used to press the plunger is dirty. Also, washing other dirty objects, such as dishes, usually takes both hands because it takes one hand to hold the object and one to scrub the dirt off of the object. The valves currently available on portable coolers require that the user keep one hand on the valve at all times.

Accordingly, it is an object of the present invention to provide a valve activator device which retains the plunger in a depressed position so that fluid from the cooler can continually flow from the cooler.

### SUMMARY OF THE INVENTION

In accordance with the present invention, a Portable Cooler Valve Activator is provided and includes an activator with a body that has two inward extending capturing tabs at one end of the body and a plunger tab located between the capturing tabs. The inward curves of the capturing tabs form two flange gaps. The capturing tabs are placed over the flanges of a portable cooler valve while the plunger tab pushes the plunger of a portable cooler valve. The pressing of the plunger allows fluid to flow from inside of the portable cooler out the spout of the portable cooler valve. The flanges of the portable cooler valve are inserted within the flange gaps and are securely held in place by the surrounding capturing tabs. A securely held Portable Cooler Valve Activator will depress and hold the plunger of a portable cooler valve, resulting in a continuous flow of fluid.

The Portable Cooler Valve Activator may be constructed of metal, plastic, vinyl, or any other solid material which will not deteriorate with exposure to the variety of fluids stored in portable coolers.

Also, the Portable Cooler Valve Activator of the present invention may be attached to the valve of a portable cooler with a strap. The type of strap may be a string, chain, or other material used to attach one object to another. The present invention can hang from the portable cooler when not used.

The Portable Cooler Valve Activator as described above will overcome the disadvantages associated with the use of portable coolers. For example, the Portable Cooler Valve Activator of the present invention allows a user to wash a hand, dirty object, or to get a glass of fluid without having to hold the plunger in a depressed position by a finger or thumb.

### DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front perspective view showing a typical portable cooler 150 equipped with a valve, and showing the Portable Cooler Valve Activator of the present invention connected to a portable cooler valve with a strap;

FIG. 2 is a top view of the Portable Cooler Valve Activator of the present invention showing a body, a plunger tab formed with capturing tabs, having flange gaps and ridge dimples, and formed with a strap hole and a grip area;

FIG. 3 is a cross-sectional view of the Portable Cooler Valve Activator taken along line 3-3 in FIG. 1 and showing the present invention as it is engaged to a portable cooler valve; and

FIG. 4 is an alternative embodiment of the Portable Cooler Valve Activator of the present invention.

### DETAILED DESCRIPTION

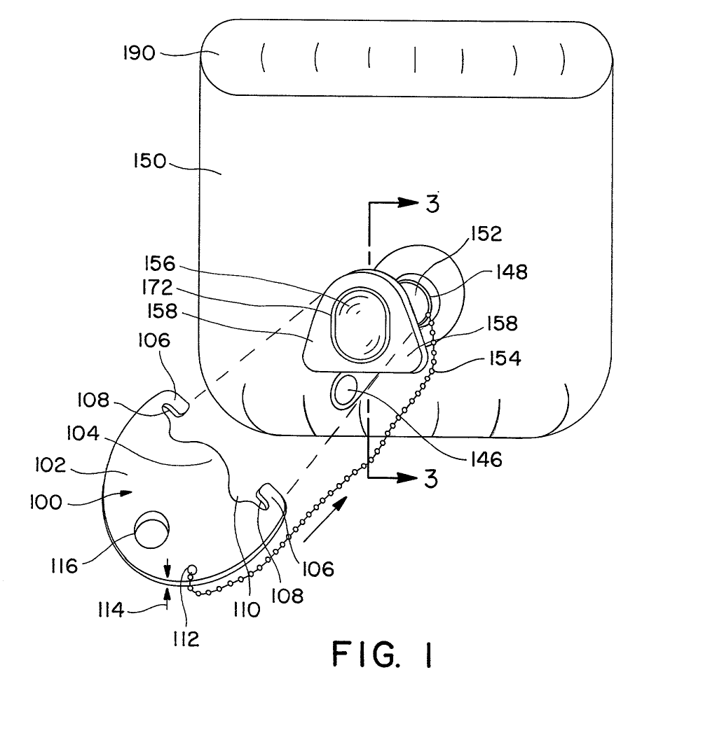

Referring initially to FIG. 1, the Portable Cooler Valve Activator of the present invention is generally designated 100 and is shown attached to valve 152 of a typical portable cooler 150 with strap 154. Portable Cooler Valve Activator 100 includes body 102, plunger tab 104, capturing tabs 106 forming flange gaps 108, ridge dimples 110, and formed with a strap hole 112 and thumb grip hole 115. The thickness 114 of Portable Cooler Valve Activator 100 may be approximately 1/4 inch, but may vary depending on the material used.

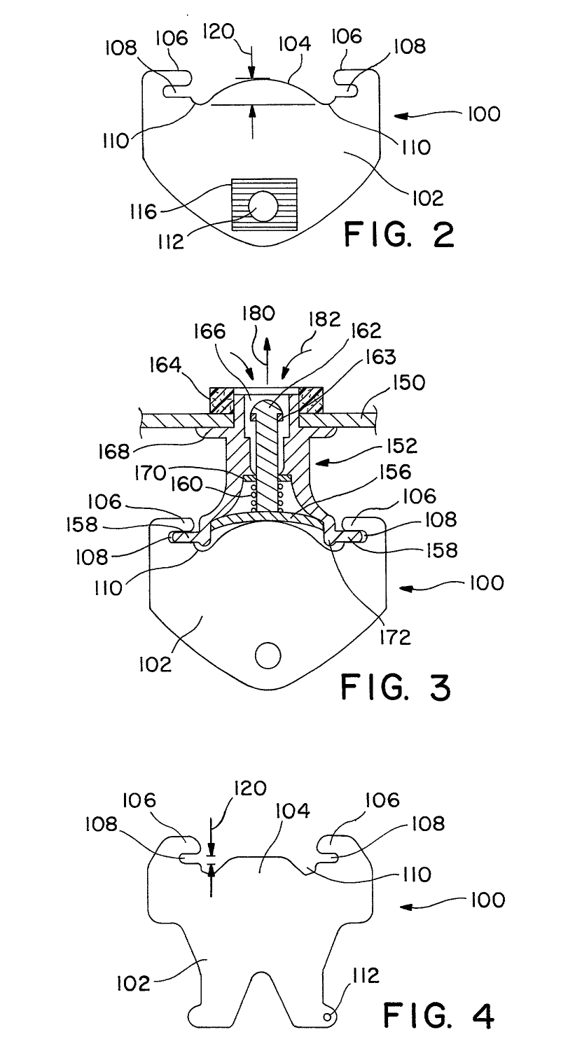

In a preferred embodiment, body 102 of Portable Cooler Valve Activator 100 may be constructed in a half circle shape, but other shapes may be used. Also, body 102 may be constructed of polymer, metal, or other solid material which does not deteriorate from exposure to fluids. Thickness 114 of body may vary to accommodate the various sizes of plungers 156 found in portable cooler valves 152. Thumb grip area 115 may include a hole which allows better gripping by a thumb or finger or a textured portion as shown in FIG. 2. As shown, strap 154 secures the Portable Cooler Valve Activator 100 to valve 152, and can be constructed of chain, string, or other material known in the art.

Referring now to FIG. 2, a top view of the Portable Cooler Valve Activator of the present invention shows body 102 having plunger tab 104 and formed with capturing tabs 106 that create flange gaps 108 and ridge dimples 110, and formed with strap hole 112, thumb grip hole 115, textured grip area 116, and plunger tab width 120.

In a preferred embodiment, plunger tab 104 may have a dome shape. Plunger tab width 120 may be variable to fit the variety of plunger depths found in different models of portable cooler valves 152.

FIG. 3 is a cross-sectional view of the Portable Cooler Valve Activator taken along line 3-3 in FIG. 1 showing the present invention as it is engaged to the portable cooler valve 152. Portable cooler valve 152 includes spout 146, strap fastener 148, plunger 156, flange 158, spring 160, valve insert 162, valve seal 163, valve fastener 164, valve gap 166, valve cover 168, valve lip 170, and circumferential ridge 172. When plunger 156 is depressed, valve insert 162 is forced in direction 180 and valve seal 163 enters valve gap 166. The movement of valve insert 162 and valve seal 163 allows fluid 190 from inside portable cooler 150 to flow in direction 182 through spout 146.

FIG. 4 is an alternative embodiment of the Portable Cooler Valve Activator of the present invention and includes body 102, plunger tab 104, capturing tabs 106 forming flange gaps 108, ridge dimples 110, formed with strap hole 112, and plunger tab width 120. Capturing tabs 106 curve inward at one end of body 102. The inward curve of capturing tabs 106 form two open spaces referred to as flange gaps 108. The flange gaps 108 are designed to receive flanges 158 of the portable cooler valve 152.

In a preferred embodiment, body 102 may have a V-cut on the side nearest to the strap hole 112. Plunger tab 104 may have a plateau shape and plunger tab width 120 is variable to accommodate different size plungers 156. Strap hole 112 may be on either side of body 102 opposite from plunger tab 104.

### OPERATION OF THE INVENTION

The operation of Portable Cooler Valve Activator 100 is best discussed in conjunction with FIG. 3 and begins with a user placing and gripping his or her thumb and forefinger on opposite sides of thumb grip hole 115 or textured area 116 of Portable Cooler Valve Activator 100. Next, the user hooks one capturing tab 106A around one flange 158A so that flange 158A is inserted inside flange gap 108A. Then, the user pivots Portable Cooler Valve Activator 100 into a position where the second capturing tab 106B is next to the second flange 158B. The second capturing tab 106B is hooked around the second flange 158B so that plunger tab 104 engages and depresses plunger 156 in direction 180. Finally, with plunger 156 retained in its depressed position, portable cooler valve 152 is open and fluid 190 continuously flows from the inside of portable cooler 150 to wash both hands simultaneously or other dirty objects.

The use of Portable Cooler Valve Activator 100 ensures that dirty hands that would normally hold plunger 156 in a depressed position can now be free to be washed. Valve 152 will not be held by dirty hands, so valve 152 and plunger 156 will remain clean through extended use.

I claim:

1. A disposable portable cooler valve activator for use on a cooler valve having a flange and plunger comprising:
a body;
first capturing tab;
second capturing tab;
plunger tab between said first capturing tab and said second capturing tab; and
wherein said first capturing tab and said second capturing tab engage said flange of cooler valve and said plunger tab depresses said plunger of cooler valve.

2. The portable cooler valve activator in claim 1, wherein said body is made of polymer.

3. The portable cooler valve activator in claim 1, wherein said body is made of metal.

4. The portable cooler valve activator in claim 1, further comprising a texture grip area formed on said body.

5. The portable cooler valve activator in claim 1, wherein said body formed with a strap hole.

6. The portable cooler valve activator in claim 1, wherein said body having two flange gaps at opposite sides and forme by said capturing tabs.

7. The portable cooler valve activator in claim 6, wherein said body having a plunger tab between said capturing tabs and said flange gaps.

8. The portable cooler valve activator in claim 7, wherein said plunger tab having a dome shape.

9. The portable cooler valve activator in claim 7, wherein said plunger tab having a plateau shape.

10. The portable cooler valve activator in claim 7, wherein said body having two ridge dimples on each side of said plunger tab.
